(19) United States
(12) Patent Application Publication
(10) Pub. No.: US 2014/0351285 A1
(43) Pub. Date: Nov. 27, 2014

(54) PLATFORM AND METHOD FOR ANALYZING ELECTRIC POWER SYSTEM DATA

(71) Applicants: Jianming Liu, Beijing (CN); Jiye Wang, Beijing (CN); Ning Li, Beijing (CN); Pengzhan Fan, Beijing (CN); Fengyu Wang, Beijing (CN); Houlei Lv, Beijing (CN); Xiaozhen Li, Beijing (CN)

(72) Inventors: Jianming Liu, Beijing (CN); Jiye Wang, Beijing (CN); Ning Li, Beijing (CN); Pengzhan Fan, Beijing (CN); Fengyu Wang, Beijing (CN); Houlei Lv, Beijing (CN); Xiaozhen Li, Beijing (CN)

(73) Assignees: STATE GRID INFORMATION & TELECOMMUNICATION BRANCH, Beijing (CN); GUO DIAN TONG NETWORK TECHNOLOGY COMPANY LTD., Beijing (CN); STATE GRID CORPORATION OF CHINA, Beijing (CN)

(21) Appl. No.: 14/369,082

(22) PCT Filed: Jan. 18, 2012
(86) PCT No.: PCT/CN2012/070508

§ 371 Date: Jun. 26, 2014

(30) Foreign Application Priority Data
Dec. 29, 2011 (CN) 201110452264.7

(51) Int. Cl. G06F 17/30; G06N 99/00; G06Q 50/06

(52) U.S. Cl. CPC G06F 17/30545; G06Q 50/06; G06N 99/005
USPC 707/770

(57) ABSTRACT

Disclosed are a platform and method for analyzing electric power system data. The platform uses a cloud-distributed database to store data to be processed, performs, based on a received operating command, immediate inquiry and/or multi-dimensional analysis and/or machine learning and the like on the data to be processed so as to analyze said data, and achieves knowledge mining of said data through machine learning algorithm analysis. Through the platform and method for analyzing electric power system data disclosed in the present invention, unknown and valuable data can be extracted using a machine learning algorithm, thereby providing advantageous support for enterprise decisions.

This application claims priority to Chinese patent application No. 201110452264.7, titled “DATA ANALYZING PLATFORM OF ELECTRIC POWER SYSTEM AND DATA ANALYZING METHOD THEREOF”, filed with the State Intellectual Property Office of People's Republic of China on Dec. 29, 2011, which is incorporated herein by reference in its entirety.

### FIELD

The present disclosure relates to the field of data analysis, and in particular, to a data analyzing platform of an electric power system and a data analyzing method thereof.

### BACKGROUND

With continuous improvement of the national electric power grid level and wide applications of various smart devices, the amount of data obtained in the work of the electric power industry increases sharply.

Due to work requirements, a user needs to analyze and process acquired data. In existing information management systems of electric power grid enterprises, data is substantially stored with conventional relational databases such as Oracle and Sybase which are generally deployed with a single node. Therefore, the data is processed by taking the single node as a unit in the existing information management systems of the electric power grid enterprises. Consequently, processing on the data by the information management systems of the electric power grid enterprises are greatly limited, which basically concentrated on the data query and small scale data aggregation analysis.

The existing information management systems of the electric power grid enterprises cannot satisfy the requirements in view of increasing amount of data in the electric power grid enterprises and an urgent task of analyzing and processing large amount of data. In data processing, beyond functions of data query and data aggregation, a capability of mining unknown and valuable knowledge from the data is further required to extract valuable data to favorably support a decision of an electric power enterprise.

### SUMMARY

Accordingly, a data analyzing platform of an electric power system and a data analyzing method thereof are provided in the disclosure, to solve disadvantages of a great limitation in data processing and incapability of mining knowledge from data, due to a single node deployment applied in a relational database in conventional technologies.

In order to achieve the above object, the disclosure provides the following technical solution.

A data analyzing platform of an electric power system includes a data storage system, a management service system and a data processing system.

The data storage system is for storing, with a distributed cloud database, data to be processed.

The management service system is for sending an operation command of analyzing the data to be processed. The operation command includes an instant query, a multidimensional analysis and/or a machine learning.

The data processing system is for performing the instant query, the multidimensional analysis and/or the machine learning on the data to be processed, in response to the operation command.

The data processing system includes:
an instant query module, for querying corresponding data to be processed, in response to a received instant query request;
a multidimensional analysis module, for analyzing corresponding data to be processed, in response to a received multidimensional analysis command; and
a machine learning module, for mining corresponding data to be processed, with a corresponding machine learning algorithm in response to a received machine learning command, where the machine learning algorithm includes a clustering algorithm, a sorting algorithm, a prediction algorithm, an association analysis algorithm, an outlier analysis algorithm, a collaborative filtering analysis algorithm and/or a What-if simulation analysis algorithm.

The data to be processed is data acquired by an interne of things, a sensor or a business system

Preferably, the platform further includes:
a portal system, for providing a user with a unified operation interface.

Preferably, the platform further includes:
a showing system, for showing a processing result of the data processing system to a user.

Preferably, the platform further includes:
a business application system, for providing the user with services for different businesses.

A data analyzing method of an electric power system includes:
receiving an operation command of analyzing data to be processed, which is sent by a management service system, where the operation command includes an instant query, a multidimensional analysis and a machine learning; and
performing, by a data processing system, the instant query and/or the multidimensional analysis and/or the machine learning on the data to be processed which is stored in a distributed cloud database, in response to the operation command.

The processing performed on the data to be processed includes:
querying corresponding data to be processed, in response to a received instant query request;
and/or analyzing corresponding data to be processed, in response to a received multidimensional analysis command;
and/or mining corresponding data to be processed, with a corresponding machine learning algorithm in response to a received machine learning command, where the machine learning algorithm includes a clustering algorithm, a sorting algorithm, a prediction algorithm, an association analysis algorithm, an outlier analysis algorithm, a collaborative filtering analysis algorithm and a What-if simulation analysis algorithm.

Preferably, the method further includes:
providing a user with a unified operation interface.

Preferably, the method further includes:
showing a processing result of the data processing system to a user.

It can be seen from the above technical solution that, in comparison with the conventional technologies, the data analyzing platform of the electric power system and the data analyzing method thereof are provided in the disclosure. The platform stores, with the distributed cloud database, the data to be processed; performs, for example, the instant query and/or the multidimensional analysis and/or the machine learning on the data to be processed, in response to the received operation command of analyzing the data to be processed; and analyzes through the machine learning algorithm to perform the knowledge mining on the data to be processed. With the data analyzing platform of the electric power system and the data analyzing method thereof provided in the disclosure, unknown and valuable data may be extracted by using the machine learning algorithm, to favorably support a decision of an enterprise.

### BRIEF DESCRIPTION OF THE DRAWINGS

The drawings to be used in descriptions of embodiments or conventional technologies are described briefly hereinafter to clarify a technical solution according to the embodiments of the disclosure or according to the conventional technologies. It is obvious that the drawings in the following description are only some embodiments of the disclosure. Other drawings may be obtained by those skilled in the art based on the drawings without any creative works.

FIG. 1 is a first schematic structural diagram of a data analyzing platform of an electric power system according to an embodiment of the disclosure;

FIG. 2 is a schematic structural diagram of a data processing system 103 according to an embodiment of the disclosure;

FIG. 3 is a second schematic structural diagram of a data analyzing platform of an electric power system according to an embodiment of the disclosure; and

FIG. 4 is a flowchart of a data analyzing method of an electric power system according to an embodiment of the disclosure.

### DETAILED DESCRIPTION OF THE EMBODIMENTS

A technical solution according to embodiments of the disclosure is described clearly and completely hereinafter in conjunction with drawings in the embodiments of the disclosure. It is obvious that the described embodiments are only part of, rather than all of the embodiments of the disclosure. All other embodiments obtained by those skilled in the art based on the embodiments of the disclosure without any creative works fall in the scope of the present disclosure.

### A First Embodiment

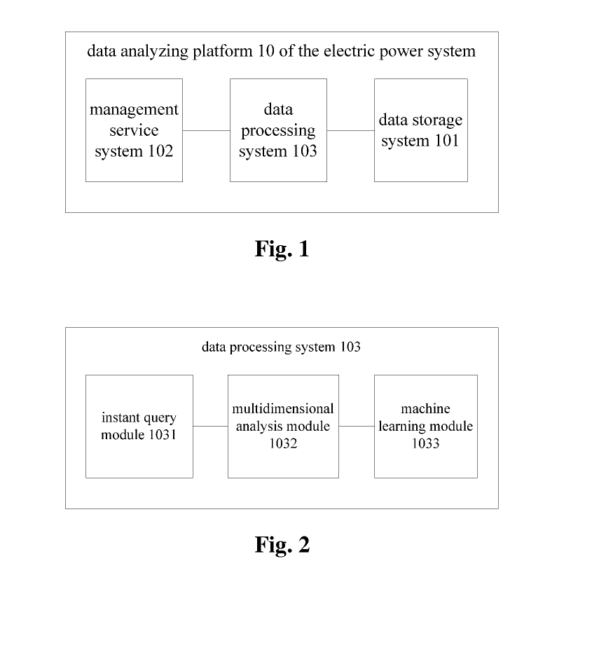

FIG. 1 illustrates a data analyzing platform of an electric power system according to an embodiment of the disclosure. As shown in FIG. 1, the data analyzing platform 10 of the electric power system may include a data storage system 101, a management service system 102 and a data processing system 103.

The data storage system 101 is for storing, with a distributed cloud database, data to be processed.

The data to be processed is data acquired by an interne of Things, a sensor business or a business system. Moreover, the data storage system 101 provides an interface between the data analyzing platform 10 of the electric power system and a sensing device, and also provides an Extraction-Transform-Loading (ETI) service, which is relational database-oriented such as Oracle-oriented or Sybase-oriented, to import data from a relational database to the data analyzing platform 10 of the electric power system.

Under a premise of storing, with the distributed cloud database, the data to be processed, a system may process the data with a parallel computing technology. To store, with the distributed cloud database, the data to be processed, a large data file is divided into multiple parts and the multiple parts are stored on different nodes in a cloud cluster. And to implement the parallel computing, an algorithm to be performed is distributed to each storage node and performed respectively by each storage node, and then results of all nodes are aggregated to obtain a final result. An implementation of the parallel computing technology provides a basis for analyzing the data with a machine learning algorithm in a later step. Moreover, with a storage approach based on the distributed cloud database, a storage capacity and a computing capability of the system may be expanded by adding nodes into the cloud cluster.

The management service system 102 is for sending an operation command of analyzing the data to be processed. The operation command includes an instant query, a multidimensional analysis and/or a machine learning.

Processing the data to be processed and what kind of processing is performed are controlled by this module. That is, a user may send, through the module, a command of operating the data to be processed. According to other embodiments, the management service system 102 may further provide services including an authority control and a work flow management.

The data processing system 103 is for performing the instant query, the multidimensional analysis and/or the machine learning on the data to be processed, in response to the operation command.

A structure of the data processing system 103 may be referred to FIG. 2. FIG. 2 is a schematic structural diagram of the data processing system 103 according to an embodiment of the disclosure. As shown in FIG. 2, the data processing system 103 may includes an instant query module 1031, a multidimensional analysis module 1032 and a machine learning module 1033.

The instant query module 1031 is for querying corresponding data to be processed, in response to a received instant query request.

The module may rapidly respond to the query request from a user.

The multidimensional analysis module 1032 is for analyzing corresponding data to be processed, in response to a received multidimensional analysis command.

The multidimensional analysis module 1032 may analyze a same set of data with different perspectives. For example, data related to an electricity consumption in one quarter of Beijing may be analyzed based on time. The electricity consumption of each month in the quarter may be calculated. Alternatively, it may be analyzed based on regions where electricity is consumed, for example, the electricity consumptions of Haidian district, Chaoyang district and Fengtai district in a same period of time are calculated.

The machine learning module 1033 is for mining corresponding data to be processed, with a corresponding machine learning algorithm in response to a received machine learning command.

The machine learning algorithm may include a clustering, a sorting, a prediction, an association analysis, an outlier analysis, a collaborative filtering analysis and a What-if simulation analysis. With the above machine learning algorithms, valuable data may be found by mining knowledge from massive data. For example, in the story of “beer and diapers”, by analyzing retail data of a certain supermarket with the association analysis algorithm in data mining, it is found that a consumer buys the beer and the diapers at the same time with a high frequency. Therefore, the supermarket sells the above two productions together, and accordingly, the sales is improved greatly.

According to the embodiment, the data analyzing platform of the electric power system stores, with the distributed cloud database, the data to be processed; performs, for example, the instant query and/or the multidimensional analysis and/or the machine learning on the data to be processed, in response to the received operation command of analyzing the data to be processed; and performs the knowledge mining on the data to be processed, with the machine learning algorithm. With the data analyzing platform of the electric power system disclosed herein, unknown and valuable data may be extracted through the machine learning algorithm to favorably support a decision of an enterprise.

### A Second Embodiment

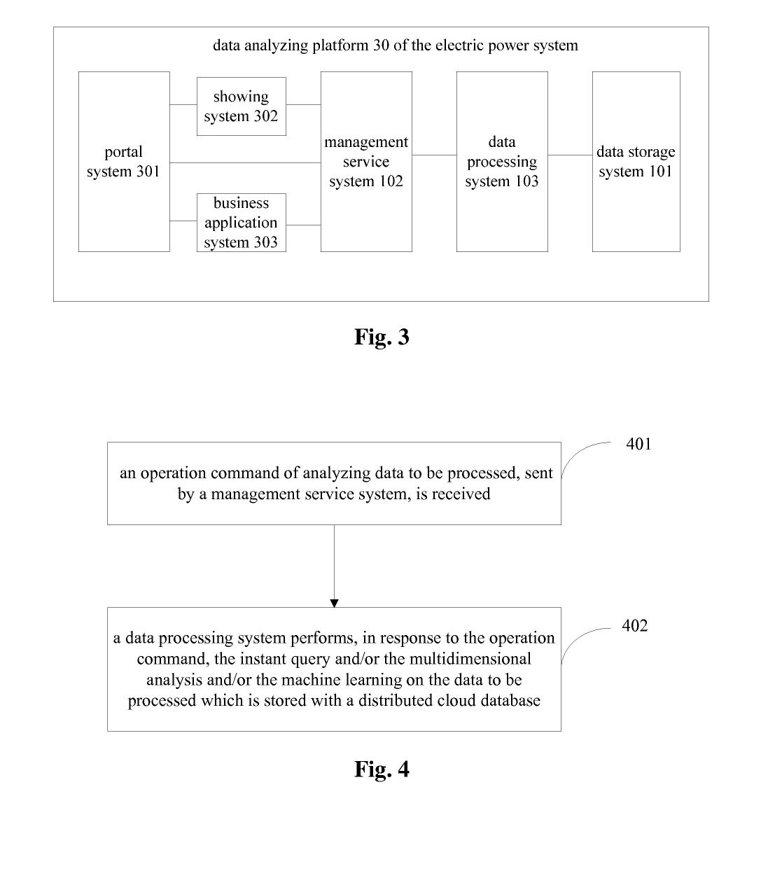

FIG. 3 is a second schematic structural diagram of a data analyzing platform of an electric power system according to an embodiment of the disclosure. As shown in FIG. 3, the data analyzing platform 30 of the electric power system may include a data storage system 101, a management service system 102, a data processing system 103, a portal system 301, a showing system 302 and a business application system 303.

The data storage system 101 is for storing, with a distributed cloud database, data to be processed.

The management service system 102 is for sending an operation command of analyzing the data to be processed. The operation command includes an instant query, a multidimensional analysis and/or a machine learning.

The data processing system 103 is for performing the instant query, the multidimensional analysis and/or the machine learning on the data to be processed, in response to the operation command.

The portal system 301 is for providing a user with a unified operation interface.

The portal system 301 may provide the user with a unified entrance and an easy-to-use operation interface. The system provides the user with various functions or systems through graphics or texts. Complicated technologies and processes in the background are invisible to the user. The user may analyze massive data by operating with a mouse. It is advantageous to apply the platform in an actual production environment.

The showing system 302 is for showing a result of a processing performed by the data processing system to the user.

The system may show the result of the processing performed, by the data processing system 103, on the data to be processed to the user in form of, for example, a list, a crosstab, a pie chart and a histogram.

The business application system 303 is for providing the user with services for different businesses.

There may be multiple businesses and the businesses may be set in different levels by the user based on importances. Some common business types are finance, marketing, human resources and supplies.

According to the embodiment, the data analyzing platform of the electric power system stores, with the distributed cloud database, the data to be processed; performs, for example, the instant query and/or the multidimensional analysis and/or the machine learning on the data to be processed, in response to the received operation command of analyzing the data to be processed; and analyzes through the machine learning algorithm to perform the knowledge mining on the data to be processed. In addition, the platform may provide the user with the unified and easy-to-use entrance and show the result of the processing performed on the data to the user in form of a report, and the user may set multiple specialized business systems in service of the work. With the data analyzing platform of the electric power system disclosed herein, the user in an electrical power enterprise may process and manage massive data easily, and unknown and valuable data may be extracted by using the machine learning algorithm to favorably support a decision of the enterprise.

### A Third Embodiment

FIG. 4 is a flowchart of a data analyzing method of an electric power system according to an embodiment of the disclosure. As shown in FIG. 4, the method may include steps 401-402.

In the step 401, an operation command of analyzing data to be processed, sent by a management service system, is received. The operation command includes an instant query, a multidimensional analysis and a machine learning.

In the step 402, a data processing system performs, in response to the operation command, the instant query and/or the multidimensional analysis and/or the machine learning on the data to be processed which is stored with a distributed cloud database.

Processing the data to be processed in response to the operation command may include: querying corresponding data to be processed, in response to a received instant query request; and/or analyzing corresponding data to be processed, in response to a received multidimensional analysis command; and/or mining corresponding data to be processed, with a corresponding machine learning algorithm in response to a received machine learning command. The machine learning algorithm includes a clustering algorithm, a sorting algorithm, a prediction algorithm, an association analysis algorithm, an outlier analysis algorithm, a collaborative filtering analysis algorithm and a What-if simulation analysis algorithm.

According to other embodiments, steps of providing a user with a unified operation interface and/or showing a data processing result to the user may further be included.

According to the embodiment, an object analyzed with the data analyzing method of the electric power system is the data to be processed which is stored with the distributed cloud database. With the method, processings such as the instant query and/or the multidimensional analysis and/or the machine learning may be performed on the data to be processed, in response to the received operation command of analyzing the data to be processed, and the knowledge mining may be performed on the data to be processed, by analyzing with the machine learning algorithm. With the data analyzing method of the electric power system disclosed herein, unknown and valuable data may be extracted by using the machine learning algorithm, to favorably support a decision of an enterprise.

The embodiments of the disclosure are described in a progressive manner. Differences form other embodiments are emphasized in the explanation of each embodiment, and same or similar parts among the embodiments can be referred to each another. The device disclosed according to the embodiment is briefly described since it corresponds to the method disclosed according to the embodiment. Relevant portions may be referred to the description of the method.

It should be noted that, relational terms such as first and second are only used herein to distinguish an entity or operation from another entity or operation, while it is not necessarily required or implied that there is any actual relationship or order of this kind between those entities and operations. Moreover, terms of ‘comprise’, ‘include’, and any other variants are intended to be non-exclusive. Hence, a process, a method, an article or a device including a series of elements includes not only those elements, but also other elements that are not clearly listed or inherent elements of the process, method, article or device. In case of no more restrictions, an element limited by the statement ‘include one . . . ’ do not exclude that other similar elements also exist in the process, method, article or device including the element.

Steps of the method or algorithm described according to the embodiments of the disclosure may be implemented through any one or a combination of hardware and a software module executed by a processor. The software module may be installed in a Random Access Memory (RAM), a Read Only Memory (ROM), an electrically programmable ROM, an electrically erasable programmable ROM, a register, a hard disk, a removable magnetic disk, a Compact Disc Read Only Memory (CD-ROM) or a storage medium in any other forms well known in the conventional art.

Those skilled in the art may implement or use the present disclosure based on the descriptions of the embodiments of the disclosure. Numerous modifications to the embodiments may be apparent to those skilled in the art, and the general principle herein can be implemented in other embodiments without deviating from the spirit or scope of the present disclosure. Therefore, the present disclosure may not be limited to the embodiments described herein and is in accordance with a widest scope consistent with the principle and novel features disclosed herein.

1. A data analyzing platform of an electric power system, comprising a data storage system, a management service system and a data processing system, wherein:
the data storage system is configured to store, with a distributed cloud database, data to be processed;
the management service system is configured to send an operation command of analyzing the data to be processed, wherein the operation command comprises an instant query, a multidimensional analysis and/or a machine learning; and
the data processing system is configured to perform the instant query, the multidimensional analysis and/or the machine learning on the data to be processed, in response to the operation command.

2. The platform according to claim 1, wherein the data processing system comprises:
an instant query module, configured to query corresponding data to be processed, in response to a received instant query request;
a multidimensional analysis module, configured to analyze corresponding data to be processed, in response to a received multidimensional analysis command; and
a machine learning module, configured to mine corresponding data to be processed, with a corresponding machine learning algorithm in response to a received machine learning command, wherein the machine learning algorithm comprises a clustering algorithm, a sorting algorithm, a prediction algorithm, an association analysis algorithm, an outlier analysis algorithm, a collaborative filtering analysis algorithm and/or a What-if simulation analysis algorithm.

3. The platform according to claim 1, further comprising:
a portal system, configured to provide a user with a unified operation interface.

4. The platform according to claim 1, further comprising:
a showing system, configured to show a processing result of the data processing system to a user.

5. The platform according to claim 1, wherein the data to be processed is data acquired by an interne of things, a sensor or a business system.

6. The platform according to claim 1, further comprising:
a business application system, configured to provide a user with services for different businesses.

7. A data analyzing method of an electric power system, comprising:
receiving an operation command of analyzing data to be processed, which is sent by a management service system, wherein the operation command comprises an instant query, a multidimensional analysis and a machine learning; and
performing, by a data processing system, the instant query and/or the multidimensional analysis and/or the machine learning on the data to be processed which is stored with a distributed cloud database, in response to the operation command.

8. The method according to claim 7, wherein the processing performed on the data to be processed comprises:
querying corresponding data to be processed, in response to a received instant query request;
and/or analyzing corresponding data to be processed, in response to a received multidimensional analysis command;
and/or mining corresponding data to be processed, with a corresponding machine learning algorithm in response to a received machine learning command, wherein the machine learning algorithm comprises a clustering algorithm, a sorting algorithm, a prediction algorithm, an association analysis algorithm, an outlier analysis algorithm, a collaborative filtering analysis algorithm and a What-if simulation analysis algorithm.

9. The method according to claim 7, further comprising:
providing a user with a unified operation interface.

10. The method according to claim 7, further comprising:
showing a processing result of the data processing system to a user.
